(19) United States
(12) Patent Application Publication
(10) Pub. No.: US 2007/0267215 A1
(43) Pub. Date: Nov. 22, 2007

(54) Plastic Compound, Product Composed of Said Compound and Use of Said Compound

(75) Inventors: Oliver Dernovsek, Graz (AT); Steffen Walter, Harthausen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate, GmbH, Munich (DE)

(21) Appl. No.: 10/561,004

(22) PCT Filed: Jun. 28, 2004
(86) PCT No.: PCT/EP04/51267

§ 371 Date: Jan. 31, 2007

(30) Foreign Application Priority Data
Jun. 27, 2003 (DE) 103 29 117.2

(51) Int. Cl. C03C 14/00; C08K 3/40; C08L 83/04; H01B 3/30; H01B 7/295

(52) U.S. Cl. 174/110 A; 501/32; 501/41; 501/43; 501/49; 501/53

(57) ABSTRACT

A plastic compound includes at least one polymer and at least one organic starting compound having a decomposition temperature T_{z} and formed of at least one ceramic material comprising a glass and/or a starting material of glass. Also, the plastic compound includes at least one glass material for forming a glass ceramic with the aid of the at least one ceramic material, the glass having a glass transition point T_{g} that substantially corresponds to the decomposition temperature T_{z} of the organic starting compound.

The invention relates to a plastic compound, comprising at least one polymer, at least one organic starting compound of at least one ceramic material and at least one glass material for forming a glass ceramic with the ceramic material, which comprises a glass and/or a starting material of glass. In addition to the plastic compound, a product comprising said plastic compound and a use of said plastic compound is specified.

A plastic compound of said type, a product comprising said plastic compound and use of said plastic compound are known from WO 01/85634. The plastic compound can be ceramicised. This means that the plastic compound can be converted into a ceramic material by a thermal decomposition (pyrolysis). The polymer of the plastic compound is a base material of which the plastic compound principally consists. The base material of the plastic compound is, for example, a polyorganosiloxane (polysiloxane, silicone, [R₂(SiO)]ₓ). The polyorganosiloxane, for example, poly(dimethylsiloxane) ([CH₃)₂(SiO)]ₓ) is not only the base material of the plastic compound but also the organic starting compound of the ceramic material of the plastic compound. In addition to the polyorganosiloxane, the plastic compound comprises an inorganic starting material of the ceramic material, for example aluminum oxide (Al₂O₃). The glass material for forming the glass ceramic is, for example, a borosilicate glass. As a result of the thermal decomposition of the plastic compound, a glass ceramic is formed, comprising ceramic phases and glass phases.

During the thermal decomposition of the polyorganosiloxane in air (decomposition temperature T_{z} of about 500° C.), a more or less porous amorphous parent structure (matrix) is initially formed from silicon dioxide (SiO₂). The silicon dioxide reacts at higher temperatures (1000° C. to 1200° C.) with the aluminum oxide to form the ceramic material in the form of an alumo or aluminum silicate. The ceramic material is, for example, the aluminum silicate mullite (Al₂O₃×SiO₂). As a result of the presence of borosilicate glass, a glass ceramic is formed with the ceramic material. The borosilicate glass has a glass transition point T_{g} of about 560° C. At a temperature below the formation temperature of the ceramic material, the borosilicate glass already results in a compaction of the starting compounds and/or intermediate products of the ceramic material as a result of viscous flow. A high-density glass ceramic is thereby formed from the initially porous parent structure of silicon dioxide.

The plastic compound is used for example as FRNC (flame retardant non corrosive) cable sheathing for electrical insulation of a cable. In the event of a cable fire, thermal decomposition of the plastic compound takes place. In this case, a dense, mechanically loadable, electrically insulating layer of glass ceramic is formed from the cable sheathing. The function of the cable is retained at least for a certain time even in the event of a fire. Any failure of the cable function as a result of a cable fire is delayed.

The plastic compound is converted into a very dense glass ceramic during a time-dependent thermal decomposition which is associated with a very rapid increase in temperature. A dense, electrically insulating layer of glass ceramic is obtained. However, thermal decomposition of the plastic compound associated with a relatively slow increase in temperature is problematical. The porous parent structure of silicon dioxide is initially formed, without any compaction being able to be initiated by the borosilicate glass. As a consequence, no dense glass ceramic is obtained. A layer of glass ceramic resulting from a cable fire is not dense. The function of the cable cannot be ensured over a fairly long period in the event of a fire.

It is the object of the present invention to provide a plastic compound which results in a dense glass ceramic during thermal decomposition accompanied by a relatively slow increase in temperature.

A plastic compound, comprising at least, one polymer, at least one organic starting compound of at least one ceramic material and at least one glass material for forming a glass ceramic with the ceramic material, which comprises a glass and/or a starting material of glass, is provided to achieve the object. The plastic compound is characterised in that the glass has a glass transition point T_{g} which substantially corresponds to a decomposition temperature T_{z} of the organic starting compound.

According to a second aspect of the invention, a product comprising the plastic compound is provided for chemical and/or electrical insulation of at least one component of the product.

According to a further aspect of the invention, the plastic compound is used to produce a glass ceramic by thermal decomposition of the plastic compound.

The organic starting compound of the ceramic material is decomposed by pyrolysis of the plastic compound. The organic starting compound is especially a polyorganosiloxane. The polyorganosiloxane is for example poly(dimethylsiloxane). Polyorganosiloxanes have a decomposition temperature T_{z} of below 500° C. In this case a porous parent structure of silicon dioxide or silicon oxycarbide is formed. Glass is now infiltrated into this porous parent structure at a relatively low temperature. This achieved because the glass used has a low viscosity at the decomposition temperature T_{z} of the organic starting compound. As a result of capillary forces, the more or less liquid glass is infiltrated into the developing porous parent structure of silicon dioxide. Compaction of the starting materials of the glass ceramic or the intermediate stages of the glass ceramic is thus ensured even during thermal decomposition which is accompanied by a relatively slow increase in temperature. The result is a glass ceramic material having a high compactness. A solid dense layer of ash is also obtained during a rapid increase in temperature. A kinetically uninhibited glass phase formation of the glass ceramic composition takes place which results in passivation both in the event of a rapid and also in the event of a slow fire or at different flame temperatures.

Any organic or organometallic compounds are feasible as organic starting compounds. The polymer itself is preferably the organic starting compound. For example, the organic starting compound is a silicon-organic polymer such as polysilane, polycarbosilane, polysilazane or polyorganosiloxane. A mixture of different polymers or a copolymerisate of different organometallic or non-organometallic monomers is also feasible. The organic starting compound can be polymerised or present as the monomer. Monomer means that the organic starting compound is non-cross-linked and polymerised means that the organic starting compound is partly or completely cross-linked. The organic starting compound can form the base material of the plastic compound. It is also feasible that the organic starting compound is an admixture of the base material of the plastic compound. As an admixture it is especially also feasible that the organic starting compound is an organometallic salt or an organometallic complex. In relation to said organic starting compounds the glass in particular has a glass transition point T_{g} of below 500° C. If the organic starting compound only decomposes at higher temperature, a glass having a glass transition point T_{g} higher than 500° C. can also be used.

The ceramic material and/or the glass ceramic comprising the ceramic material especially comprise at least one element selected from the group aluminum, boron, barium, bismuth, calcium, magnesium, nitrogen, oxygen, silicon, titanium, zinc and/or zirconium. In particular, the ceramic material is a silicate. The silicate is preferably an alumo or aluminum silicate. Such silicates are, for example, mullite, sillimanite or kyanite.

In one particular embodiment the polymer of the plastic compound and/or the organic starting compound of the ceramic material has a halogen fraction of less than one mol. %. Cable sheathings made of halogen-containing polymers are usually used for fire protection of a cable. A common, barely combustible polymer is, for example, polyvinylchloride (PVC). Halogen or halogen compounds of these halogen-containing polymers split halogens or halogen compounds during thermal decomposition. The halogens or halogen compounds result in stemming of a fire of the plastic compound. However, released halogens and halogen compounds can result in high pollution of the environment. For example, hydrochloric acid (HCl) is formed during the thermal decomposition of polyvinyl chloride. In contrast, the plastic compound is almost halogen-free so that halogens or the acids of halogens are not released during a fire of the plastic compound. Stemming of the fire or preserving the function of the electrical components of the products affected by a fire is ensured when using the plastic compound even in the absence of halogens or halogen compounds.

Glasses having a low glass transition point T_{g} are known. These glasses are in particular glasses comprising alkali, lead and/or phosphate ions. These glasses can release reaction products hazardous to health. Thus, phosphoric acid can be produced from glasses containing phosphate ions. Glasses containing lead ions present pollution of the environment merely as a result of the presence of lead. In addition, both glasses containing lead ions and those containing alkali ions are distinguished by a relatively high electrical conductivity. With regard to good electrical insulation and with regard to a high environmental compatibility, in a particular embodiment of the invention the glass has an alkali ion fraction and/or a lead ion fraction and/or a phosphate ion fraction of respectively less than one mol. %. This ensures that the glass ceramic produced by thermal decomposition of the plastic compound has a low electrical conductivity. This is important in connection with the electrical insulation effect of the glass ceramic formed during the thermal decomposition of the plastic compound. In addition, the plastic compound or the reaction product of the plastic compound is environmentally compatible. In particular, it contains almost no lead ions. In addition, no phosphoric acid is formed during the thermolysis. Like the hydrochloric acid which is released during the thermal decomposition of PVC, the phosphoric acid would present a direct environmental health hazard in the event of a fire of the plastic compound.

In a further embodiment, at least one inorganic starting material of the ceramic material is present. The inorganic starting material can be present as a salt or itself as the ceramic material. In particular, the inorganic starting material is aluminum oxide. Other inorganic starting materials, for example, silicon carbide (SiC) are also feasible. These starting materials can already be present in a reactive form. This means that the starting materials react directly with the parent structure produced by the thermal decomposition of the inorganic starting material or with the material of the parent structure. The ceramic material is formed at the same time. The inorganic starting materials are preferably present as oxides. It is also feasible that the reactive inorganic starting material is formed in the thermal decomposition of the plastic compound into the inorganic starting material which is actually reactive to the material of the parent structure. Such inorganic starting materials are especially carbonates or hydroxides. By supplying energy (as a consequence of the in crease in temperature in the event of a fire), these starting compounds are converted into the oxidic reactive forms. The reaction is accelerated by supplying energy. At the same time, energy can be removed from the entire system, which can contribute to slowing of the fire. Thus, for example, aluminum oxide is formed from aluminum hydroxide ((Al(OH)₃) by removal of water.

Carbonates additionally have the advantage that in a low-temperature range, that is a range below the temperature at which the ceramic material is formed, the combustibility of the plastic compound is reduced by releasing carbon dioxide (CO₂).

In a particular embodiment, the inorganic starting material and/or the glass material comprises a powder with powder particles having an average powder particle size D₅₀ of less than 3 μm and especially of less than 1.5 μm. The inorganic starting compound is especially aluminum oxide. The aluminum oxide is present as a fine powder homogeneously distributed in the plastic compound. In this form, the aluminum oxide has two functions. The aluminum oxide reacts with pyrolysis products of the organic starting compound to form ceramic material. Since the fine particles of aluminum oxide have a large surface area, these are distinguished by a high reactivity. As a result, the temperature at which the ceramic material or materials is formed is reduced. In addition, the fine powder particles of aluminum oxide act as crystallisation nuclei for the formation of the glass ceramic. This has the result that not only the ceramic material but also the glass ceramic is formed at a relatively low temperature.

A volume fraction of the glass to the plastic compound and/or a volume fraction of the starting material of the glass to the plastic compound is advantageously selected from the range of 1 vol. % to 30 vol. % and especially from the range of 5 vol. % to 15 vol. %. This relatively small volume fraction of the glass is sufficient to obtain a compact glass ceramic during thermal decomposition of the plastic compound. In this case, a low-melting glass solder can be used. Glass solder is inexpensive. Furthermore, the glass transition point T_{g} of the glass solder can be varied over a wide range so that the viscosity of the glass solder can easily be adapted to the decomposition temperature T_{z} of the organic starting compound.

The glass material preferably comprises highly reactive glasses. Such glasses are especially glasses comprising boron oxide (B₂O₃), bismuth oxide (Bi₂O₃), zinc oxide (ZnO) and small fractions of silicon dioxide. These highly reactive glasses have the result that compaction, that is the formation of the glass ceramic, takes place at relatively low temperatures. In this case, the compaction takes place substantially not by viscous flowing, as in the case of borosilicate glasses but by reactive liquid phase sintering.

The plastic compound is especially suitable for the chemical and/or electrical insulation of at least one component of the product. The product is a fire-proof product. Any product is feasible in this case. In particular, the product is a household appliance and the component an electrical component of the household appliance. The plastic compound is processed for example into a flame-retardant board or a fire-proof rubber seal so that the component of the household appliance is protected from a fire. The processing to form a flame-retardant board or a rubber seal can take place in a pressing or injection moulding process.

In a particular embodiment, the component of the product has a cladding with the plastic compound. Such a product is especially an optical conductor or a cable. The component of such a product is a cable core of the cable. The cladding is a cable sheathing of the cable core. The cable sheathing is used for the electrical insulation of the cable core. In the event of a cable fire which results in thermal decomposition of the plastic compound of the cable sheathing, a dense, mechanically loadable and electrically insulating glass ceramic is formed which takes over the function of the cable sheathing originally provided. As a result of these properties of the plastic compound, the cable sheathing can be used as FRNC cable sheathing. An extrusion method is used for example to produce the cable sheathing.

In the event of a fire, the plastic compound has the result that the electrical insulation of the product or the component of the product is preserved. In addition, the glass ceramic produced during the thermal decomposition of the plastic compound has the result that the component is chemically insulated. A dense coating of the component which is almost impermeable to chemicals is formed. The coating acts as a barrier for the chemicals. Thus, a constituent of the component cannot come in contact with a constituent of the surroundings of the component and react accordingly. A cable could, for example have an outer and an inner cable sheathing. The cable sheathing comprising the plastic compound forms the outer cable sheathing. The inner cable sheathing is arranged between the outer cable sheathing comprising the plastic compound and the cable core and consists of an inexpensive, highly combustible plastic. If a cable fire should occur, a dense layer of glass ceramic is formed from the outer cable sheathing comprising the plastic compound, which ensures that oxygen for example does not reach the highly combustible plastic of the inner cable sheathing. The inner cable sheathing does not burn and remains intact so that in the event of a fire, the electrical insulation of the cable core is ensured. The outer cable sheathing is produced for example by brushing or spraying a thin layer of the plastic compound comprising non-cross-linked or partially cross-linked polymer on the applied inner cable sheathing. Cross linking of the polymer is then initiated. A fire-proof coating is formed from the ceramicizable plastic.

It is also feasible that, in addition to the plastic compound, the cladding of the component of the product also comprises, for example, highly combustible and non-ceramicizable plastic compounds. A mixture of ceramicizable plastic compound and non-ceramicizable but highly combustible plastic compound is present. In this case, the degree of filling of the ceramicizable plastic compound is selected to be so high that in the event of a fire, a dense glass ceramic layer is formed. As a result of the dense glass ceramic layer formed in the event of a fire, almost no exchange of materials can take place with the environment. Thus, no oxygen can reach the highly combustible plastic compound. The cable fire can be stemmed.

To sum up, the following essential advantages are obtained with the invention:
As a result of the glass used in the plastic compound or the starting compound of the glass with the glass transition point T_{g} which substantially corresponds to the decomposition temperature T_{z} of the organic starting material of the ceramic material, the glass is infiltrated into the porous structure formed by the thermal decomposition of the plastic compound. This contributes to the stability of the structure of the glass ceramic.
As a result of using highly reactive glasses, the compaction of the glass ceramic takes place by reactive liquid-phase sintering. This results in a high-density layer of glass ceramic.
As a result of the chemical, electrical and mechanical stability of the glass ceramic produced by the thermal decomposition, the plastic compound can be used as an efficient FRNC cable sheathing.

The plastic compound and a product comprising the plastic compound is described in detail hereinafter with reference to several examples and the relevant figures. The drawings are schematic and are not scale diagrams.

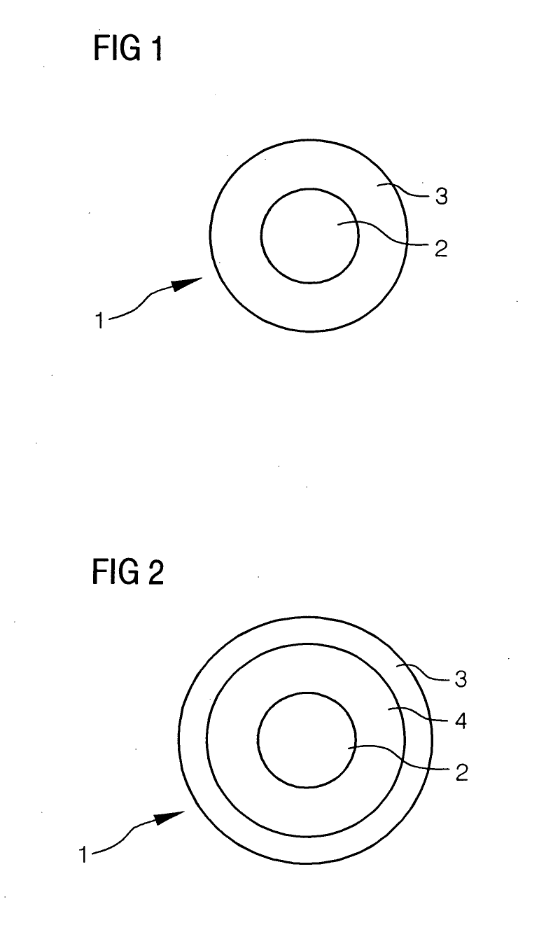

FIG. 1 shows a cross-section of an electrotechnical product comprising the plastic compound.

FIG. 2 shows a cross-section of another electrotechnical product comprising the plastic compound.

The electrotechnical product 1 is a cable comprising a cable core 2 made of an electrically conducting material and a cable sheathing 3 comprising the plastic compound. As base material the plastic compound has a polymer of poly(dimethylsiloxane). The poly(dimethylsiloxane) acts as an organic starting compound of at least one ceramic material. In addition, the plastic compound contains an inorganic starting compound of the ceramic material and a glass material to form the glass ceramic with the ceramic material. The inorganic starting compound is powdery aluminum oxide. The powder particles have an average powder particle size D₅₀ of about 1 μm. The glass material is also present in powder form with a powder particle size D₅₀ of about 1 μm.

The glass material is a glass powder mixture having the following composition: 27.5 mol. % boron oxide, 34.8 mol. % bismuth oxide, 32.5 mol. % zinc oxide and 6 mol. % silicon dioxide. The plastic compound contains about 10 vol. % of the glass powder mixture.

According to a first embodiment, the cable sheathing substantially only consists of the plastic compound (FIG. 1). In the event of a cable fire, an electrically insulating protective layer of glass ceramic is formed from the electrically insulating plastic compound.

According to a second embodiment, the cable sheathing does not only consist of the ceramicizable plastic compound. The cable sheathing additionally comprises a highly combustible elastomer. The fraction of the ceramicizable plastic compound in the cable sheathing is selected to be so high that in the event of a fire, a chemically insulating protective layer of glass ceramic is formed. This protective layer ensures that the highly combustible elastomer is largely protected from attack by oxygen. The cable fire comes to a standstill.

According to a further embodiment, the cable has an inner cable sheathing 4 and an outer cable sheathing 3 (FIG. 2). The outer cable sheathing 3 consists of the ceramicizable plastic compound. The inner cable sheathing 4 consists of a highly combustible polymer. In the event of a fire, a dense, chemically and electrically insulating protective layer of glass ceramic is formed from the outer cable sheathing. The electrically insulating inner cable sheathing remains largely preserved. The function of the cable is ensured.

To produce the cable 1 with the cable sheathing 3 made of the ceramicizable plastic compound, partially cross-linked silicon organic polymer is mixed together with the glass powder mixture and the aluminum oxide powder in a double-Z kneader and homogenised. The cable core of the cable is coated in an extruder where, by means of a sleeve head, a pre-heated wire forming the cable core is coated with a melt of the plastic compound in the extruder head. At the same time, the cross-linking of the polymer is advanced, forming the cable sheathing.

The plastic compound is distinguished by the following characteristic data, for example: average heat release rate: 80 kW/m²; time to ignition: 117 s; fire performance index: 0.98 m²/s/kW; smoke parameter: 121 (MW/kg); high ash stability.

1-17. (canceled)

18. A plastic compound, comprising:
at least one polymer;
at least one organic starting compound having a decomposition temperature T_{z} and being formed of at least one ceramic material comprising a glass and/or a starting material of glass; and
at least one glass material for forming a glass ceramic with the aid of said at least one ceramic material, the glass having a glass transition point T_{g} that substantially corresponds to the decomposition temperature T_{z} of the organic starting compound.

19. The plastic compound according to claim 18, wherein the organic starting compound is a polyorganosiloxane.

20. The plastic compound according to claim 18 or claim 19, wherein the glass transition point T_{g} of the glass lies below 500° C.

21. The plastic compound according to claim 18, wherein the glass material comprises at least one of bismuth oxide, boron oxide, silicon dioxide, and zinc oxide.

22. The plastic compound according to claim 18, wherein at least one of the ceramic material and the glass ceramic with the ceramic material comprises at least one element selected from the group Al, B, Ba, Bi, Ca, Mg, N, O, Si, Ti, Zn and/or Zr.

23. The plastic compound according to claim 18, wherein at least one of the volume fraction of the glass in the plastic compound and a volume fraction of the starting material of the glass in the plastic mass is selected from at least one of the range of 1 vol. % to 30 vol. % and the range of 5 vol. % to 15 vol. %.

24. The plastic compound according to claim 18, wherein at least one of the polymer and the organic starting compound of the ceramic material comprises a halogen fraction of less than 1 mol. %.

25. The plastic compound according to claim 18, wherein the glass comprises at least one of an alkali ion fraction, a lead ion fraction, and a phosphate ion fraction of respectively less than 1 mol. %.

26. The plastic compound according to claim 18, wherein at least one inorganic starting material of the ceramic material is present.

27. The plastic compound according to claim 26, wherein the inorganic starting material is aluminum oxide.

28. The plastic compound according to claim 26, wherein at least one of the inorganic starting material and the glass material comprises a powder with powder particles having an average powder particle size D₅₀ of a selected one of less than 3 μm and less than 1.5 μm.

29. A product comprising:
at least one component; and
a plastic compound for providing at least one of chemical insulation and electrical insulation for the at least one component, the plastic compound including at least one polymer, at least one organic starting compound having a decomposition temperature T_{z} and being formed of at least one ceramic material comprising a glass and/or a starting material of glass, and at least one glass material for forming a glass ceramic with the aid of said at least one ceramic material, the glass having a glass transition point T_{g} that substantially corresponds to the decomposition temperature T_{z} of the organic starting compound.

30. The product according to claim 29, wherein the at least one component of the product has a cladding comprising the plastic compound.

31. The product according to claim 30, wherein the cladding of the at least one component is a coating of the component.

32. The product according to claim 30, wherein the product is a cable, the at least one component is a cable core of the cable, and the cladding comprising the plastic compound is a cable sheath of the cable.

33. The product according to claim 29, wherein the product is a household appliance and the at least one component is an electrical component of the household appliance.

34. A product made by the process of:
providing at least one component; and
creating a plastic compound for providing at least one of chemical insulation and electrical insulation for the at least one component, creating the plastic compound including providing at least one polymer and at least one organic starting compound having a decomposition temperature T_{z} and being formed of at least one ceramic material comprising a glass and/or a starting material of glass and forming a glass ceramic with the aid of said at least one ceramic material via thermal decomposition of the plastic compound, the glass ceramic having a glass transition point T_{g} that substantially corresponds to the decomposition temperature T_{z} of the organic starting compound.
